(19) United States
(12) Patent Application Publication
(10) Pub. No.: US 2016/0203552 A1
(43) Pub. Date: Jul. 14, 2016

(54) VERIFICATION AND LIMITS PROCESSING

(71) Applicant: PAYPAL, INC., San Jose, CA (US)

(72) Inventors: Suresh Ganjigunta, San Jose, CA (US); Maulshree Goyal, San Jose, CA (US)

(21) Appl. No.: 15/079,004

(22) Filed: Mar. 23, 2016

Related U.S. Application Data
(63) Continuation of application No. 12/571,020, filed on Sep. 30, 2009.

(51) Int. Cl. G06Q 40/02; G06Q 20/24; G06Q 20/40

(52) U.S. Cl. CPC G06Q 40/025; G06Q 20/405; G06Q 20/24

(57) ABSTRACT

Methods and systems facilitate enhanced processing of requests for limit increases, such as credit limit increases. For example, a method can comprise receiving a request from a client computer of a user via a network and providing at least one field for the entry of information by the user. The field can be defined by either the user or the type of the request. As a further example, a system can comprise a payment provider that is configured to receive a request from a client computer of a user via a network and provide at least one field for the entry of information by the user. Again, the field can be defined by either the user or the type of the request.

### PRIORITY CLAIM

This application is a continuation of U.S. patent application Ser. No. 12/571,020, filed on Sep. 30, 2009, which is incorporated herein by reference in its entirety.

### TECHNICAL FIELD

The present invention relates generally to networking. The present invention relates more particularly, for example, to methods and systems for verifying information regarding a user and for processing a limit, such as a credit limit, of the user.

### BACKGROUND

Use of the Internet for commerce is commonplace. Online vendors, auctions, and other commercial websites are visited frequently by users. For example, consumers can purchase goods via merchants who have a presence on the Internet and can bid in auctions that take place over the Internet.

Various different methods are available for providing payment for products and services obtained via the Internet. Such methods may be facilitated by e-Commerce intermediaries. For example, PayPal® (PayPal is a registered trademark of PayPal, Inc. of San Jose, Calif.) is a well known e-Commerce intermediary or payment provider that facilitates payments and money transfers via the Internet. Thus, PayPal serves as an electronic alternative to the use of contemporary paper methods of payment, such as cash, checks, and money orders.

A PayPal account can be funded via the use of an electronic debit from a user's bank account or can be funded using a credit card. A merchant or other intended recipient of money via PayPal receives payment from the user through PayPal. For example, PayPal can send a check to the recipient, credit a PayPal account of the recipient, or directly transfer funds to a bank account of the recipient.

Although such contemporary e-Commerce intermediaries as payment providers have proven generally suitable for their intended purposes, they possess inherent deficiencies which detract from their overall effectiveness and desirability. For example, when a user desires an increase in a limit associated with the payment provider, the user must typically fill out a form that is subsequently evaluated by the payment provider to determine if the increase is permissible. The fields of such contemporary forms are predetermined and fixed.

Thus, in many instances, such contemporary forms do not allow a user to provide that particular information which the user believes is best suited for use by the payment provider in making a decision regarding the user's credit worthiness. Further, a user may be required to fill out all of the fields of the contemporary form. Filling out all of the fields of such a contemporary form can be time consuming and annoying, and can still fail to provide the most useful information available.

As such, although the prior art has recognized, to a limited extent, the problems associated with the use of contemporary limit increase methods and systems, the proposed solutions have, to date, been ineffective in providing a satisfactory remedy. Therefore, it is desirable to provide a better method and system for facilitating limit increases associated with e-Commerce intermediaries such as payment providers.

### BRIEF SUMMARY

In accordance with embodiments further described herein, methods and systems are provided that may be advantageously used in one or more verification and limits processing implementations. For example, in one embodiment, a method can comprise receiving a request from a client computer of a user via a network and providing at least one field for the entry of information by the user. The field(s) can be defined by the user (such as by using information regarding the user and/or by having the user select the field(s)) and/or can be defined by the type of the request (such as by what is being requested, the size of the limit increase requested, or any other aspect of the request).

In another embodiment, a system comprises a payment provider or the like that is configured to receive a request from a client computer of a user via a network. The payment provider can be further configured to provide at least one field for the entry of information by the user. Again, the field(s) can be defined by the user and/or the type of the request.

The information provided by the user in the field(s) of the form can be used to verify the identity or some other aspect of the user and/or can be used to determine whether or not a limit should be increased. The information provided by the user can be used for any other desired purpose.

Thus, a user can at least partially define what information is used to increase a limit, such as a credit limit, in a manner that is easy and convenient for the user. The number of fields in a form that is filled out by the user in order to request a limit increase can be reduced since the user can decide what information is most useful in requesting the increase. In this manner, superfluous information can be omitted.

These and other features and advantages of the present invention will be more readily apparent from the detailed description of the embodiments set forth below taken in conjunction with the accompanying drawings.

### BRIEF DESCRIPTION OF THE DRAWINGS

FIG. 1 is a flow chart showing a method for facilitating a limit increase associated with an e-Commerce intermediary, according to an example of an embodiment;

FIG. 2 is a block diagram showing a system for facilitating a limit increase associated with an e-Commerce intermediary, according to an example of an embodiment; and

FIG. 3 is a Limit Increase Request form, according to an example of an embodiment.

Embodiments of the present invention and their advantages are best understood by referring to the detailed description that follows. It should be appreciated that like reference numerals are used to identify like elements illustrated in one or more of the figures.

### EXAMPLES OF EMBODIMENTS

As examples, methods and systems for facilitating a limit increase associated with an e-Commerce intermediary are disclosed. The e-Commerce intermediary can be a payment provider, for example. The e-Commerce company can be a credit card company or any other type of e-Commerce company or facilitator.

According to an embodiment, a method comprises receiving a request from a client computer of a user via a network and providing at least one field for the entry of information by the user. The field can be defined by either the user or the request. The request can be a request for a limit increase. For example, the request can be a request for a credit limit increase. As a further example, the request can be a request for a score increase, such as a PayPal score increase.

The information provided by the user in the field(s) of the form can be used to verify the identity or some other aspect of the user and/or can be used to determine whether or not a limit should be increased. The information provided by the user in the filed(s) can be used for any desired purpose.

The request can be received via the Internet. The request can be received by any other type of network, including a local area network (LAN), a wide area network (WAN), and any desired combination thereof.

The fields can be selected by the user. The fields can be selected by the payment provider. For example, the fields can be selected by the payment provider based upon previously obtained information regarding the user. As a further example, the fields can be selected by the payment provider based upon a type of the request. The fields can be selected by any combination of the user and the payment provider. For example, some fields can be selected by the user and some fields can be selected by the payment provider.

The fields can facilitate the entry of loan information. For example, the fields can facilitate the entry of car loan information, home loan information, and/or any other type of loan information.

A remaining sending limit, a withdrawal limit, and/or a receiving limit can be dynamically calculated based on the limit increase. In this manner, the user can be provided with immediate feedback regarding the status and results of the request.

Verification of the user can be performed using social security number, credit history, date of birth, and/or any other desired information. Verification can be performed using information regarding previous transactions that were performed using the same or a different payment provider.

Options regarding the fields available can be presented to the user substantially in real-time. For example, the user can be presented with a list of those fields that can be requested.

Back end processing can be performed to facilitate the presentation of options regarding the fields available to the user substantially in real-time. Rule processing can be used to modify the verification process. A real-time server/daemon can be used to compute the limit and/or to provide the user with options that can be selected to increase the limit.

According to an embodiment, a system can comprise a payment provider that is configured to receive a request from a client computer of a user via a network and is configured to provide at least one field for the entry of information by the user. The field(s) can be defined by at least one of the user and the request.

The payment provider can comprise a server. The payment provider can comprise a plurality of servers. The servers can be collocated or distributed. The payment provider can comprises any desired type(s) and number of computers.

A rules engine can be in communication with the payment provider and can be configured to modify the verification process based upon at least one of the user and the request. The rules engine can be part of the server or can be in a separate computer with respect to the server. The rules engine can comprise any desired type(s) and number of computers.

According to an embodiment, specific types of information, based on the user and/or the request, are used to process the request and/or verify the user. In this manner, a user can apply for a limit increase, such as a credit limit increase, using information that the user believes will justify the limit increase.

When a user makes a request for a limit increase, such as a credit limit increase, then a payment provider such as PayPal can provide different or additional fields in the request form for the user to enter information. Such different or additional fields allow the payment provider to better process the request. For example, a user may be requested to enter home loan information, car loan information, or the like in the fields. The fields can be selected by the user, by the service provider, or by any combination thereof. In this manner, a request form can be tailored for use with a particular person.

According to an embodiment, users can be allowed to choose the verification method that is used by the payment provider to increase their limit or variable financial instrument threshold that is used for payment transactions, such as online payments to merchants for goods purchased. For example, a user's PayPal Score can be increased by allowing the user to use verification methods of their own choice.

According to an embodiment, a score system, such as a PayPal Score system, can facilitate dynamic calculation of the remaining sending, withdrawal, or receiving limits based on a user's score. For example, an increase in the score can result in a corresponding increase in the remaining sending, withdrawal, or receiving limits. Any such desired score system can be used in this manner.

According to an embodiment, a verification method can include any user identity validation such as SSN, credit history, date of birth, and Top Up. The verification method can include bank confirmation, card confirmation, and any other desired means for verification. PayPal Top Up Card is a system for helping users keep better track of their spending. The user simply tops the account with funds and then uses it like a debit card. With Top Up, it is possible to pay as you go almost anywhere you see the Visa logo.

According to an embodiment, a more configurable back end system allows user limits to be processed in real-time based on the user and/or the user request. The back end system can be any combination of humans and computers that process information from the user so as to facilitate the requested limit increase.

More particularly, when a user makes a request, such as for a credit increase, the back end system of the payment provider can provide the user with different or additional fields for the user to enter information so that the payment provider can better process the request. For example, a user may be requested to enter home loan information, car loan information, or the like and the back end system can provide a form that facilitates the entry and processing of such information. The fields can be selected by either the payment provider or by the user. Back end processing facilitates the presentation of real-time options to the user.

The same back end process can determine if the user's request is to be granted or denied. Alternatively, other processing, can make this determination. In either instance, the processing to determine if the user's request is to be granted or denied can be performed by a human, a machine, or a combination thereof.

According to an embodiment, the ability to modify a verification process uses rule processing. The rules can be predetermine or can be dynamically determined based upon factors regarding the user and/or the request.

According to an embodiment, a user can increase a credit limit by using a process that comprises selecting what information the user provides to the payment provider. The user can select one, two, three, four, or more items to provide to the payment provider. The items can be standard items that are typically provided to a payment provider in order to make such a request. The items can be non-standard items that are not typically provided to a payment provider in order to make such a request. The items can be any combination of standard items and non-standard items.

According to an embodiment, the ability to process and configure options for the purpose of validating user identity is provided. This ability makes the payment provider substantially more user friendly and desirable.

Additionally, a user can be provided with a variable financial instrument threshold for payment transactions. That is, the threshold or credit limit provided by the payment provider can be readily varied by the user in a manner that is easy and convenient for the user.

According to an embodiment, a rules engine can be used to process the configurable criteria. The rules engine can be a software based rules engine that runs on a general purpose computer, such as a network server. The rules engine can be used to determine limits, such as a user's credit limit, in substantially real-time and online. Thus, a user can access a system that calculates such a limit via the Internet, for example. The users can select the method of verification to be used in the process of determining (such as by the rules engine) if the limit should be increased.

According to an embodiment, a limitation imposed upon a financial instrument of a user account can be evaluated (such as by a rules engine) and the limitation can be changed, e.g., raised in substantially real-time. Thus, utility associated with use of the financial instrument can be substantially enhanced.

For example, the remaining sending, withdrawal or receiving limits for the user can be determined based upon the operation or transaction that the user is intending to perform. A real-time server/daemon can be used to compute the limitations and provide the user with options that can be used to lift the limitations.

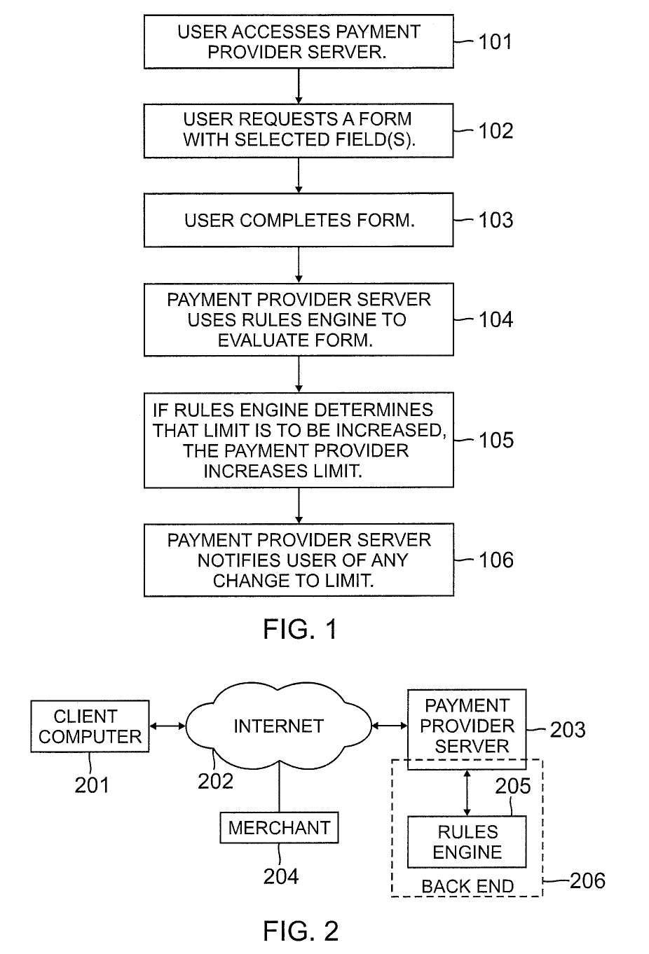

Referring now to FIG. 1, a flow chart shows a method for facilitating a limit increase associated with an e-Commerce intermediary such as a payment provider, according to an example of an embodiment. A user can access a server of the payment provider, as indicated in block 101. Typically, such access will be done online, such as via the Internet. Such access can be done via any means desired. For example, such access can be via telephone.

The user can request a form having one or more desired fields, as indicated in block 102. The fields can be selected from a list of possible fields, such as via a drop down menu. The fields can be selected by responding to one or more queries from the payment provider server, such as by typing the name or other keyword of a field into a blank or form. The fields can be selected in any desired manner. Any desired number of fields can be selected. Each field can be configured to receive information from the user.

The user can complete the form, as indicated in block 103. In completing the form, the user can provide information of the user's choosing in an attempt to have a limit associated with use of the payment provider increased. For example, the user can provide favorable information regarding a home or auto loan in the form. Since the user requests a form having one or more desired fields, these fields can be used when completing the form.

The payment provider server can use a rules engine to evaluate the form, as indicated in block 104. The rules engine can thus be used to determine whether or not the payment provider will authorize an increase in the limit.

The rules used by the rules engine can be readily modified. Modifying the rules can make it easier or more difficult for a user to obtain an increase in a limit. Modifying the rules can be done to add or delete criteria, such as the type of information or fields that a user can select to have in a form, as well as how this information is used to determine if a limit increase is to be approved.

The payment provider can, if desired, verify information provided by the user. Such information can be verified by contacting a lender, a credit agency, the user, or any other entity. Such contact can be via the Internet or via any other method desired.

If the rules engine determines that a limit should be changed, e.g., increased, then the payment provider server can increase the limit, as indicated in block 105. If the rules engine determines that a limit should not be changed, then the payment provider server can leave the limit unchanged. Optionally, the rules engine can be configured so as to determine that the limit should be lower in response to some information. In this instance, if the rules engine determines that a limit should lowered, then the payment provider server lowers the limit.

The payment provider server can notify the user of any change to the limit, as indicated in block 106. Since the rules engine can make determinations regarding such changes in substantially real-time and while the user is online, the user can be notified promptly regarding the status of such changes.

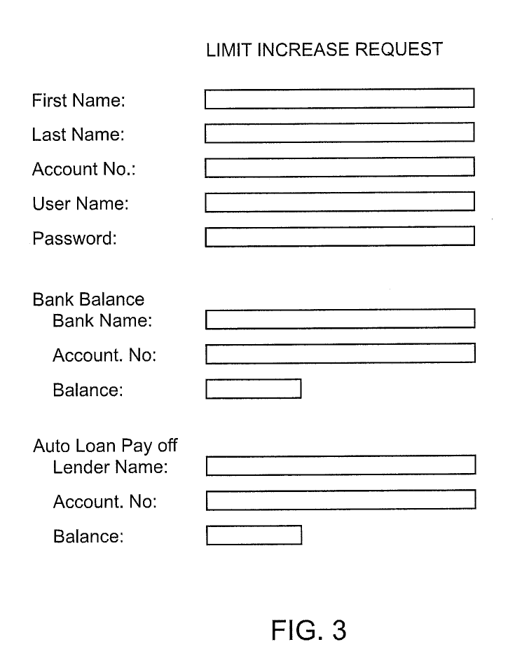

Referring now to FIG. 2, a block diagram shows a system for facilitating a limit increase associated with an e-Commerce intermediary such as a payment provider, according to an example of an embodiment. A user can use a client computer 201 to access a server 203 of the payment provider via the Internet 202, for example.

Accessing the payment provider server can be in response to a transaction with a merchant 204 that was declined because a credit limit was exceeded. Accessing the payment provider server can be in anticipation that a transaction with a merchant 204 will exceed an existing credit limit of the user.

The user can fill out a form for requesting a limit increase via the payment provider server 203. The form can contain one or more fields that were selected by the user so as to better facilitate an evaluation of the user's credit worthiness.

The payment provider server 203 can use a rules engine 205 to determine if the user's credit limit should be increased, as discussed above. The rules engine 205, as well as at least a portion of the payment provider server 203, can facilitate back end operations. Back end processing can be defined to include operations whose details are not readily visible or apparent to the user. For example, the calculations and algorithms which are applied to parameters obtained via the form and which are used to determine a credit limit can be back end operations.

Referring now to FIG. 3, an example of a form having fields determined by the user is provided. In this instance, the user has decided to include fields relating to the user's bank balance and a paid off auto loan. The use of this form is discussed in the example of operation below.

As an example of operation, a user can attempt to send money to a merchant via PayPal and get blocked by exceeding the user's sending limit. Thus, the user will desire an increase in the sending limit. Of course, this is only an example and the systems and methods disclosed herein can be used for obtaining an increase in any other type of limit. The increase limit can be for any funding source and is not limit to funding from banks and the like. Thus, the increased spending limit can be used for any funding source (such as a user's alternate debit card, credit card, alternate bank account, etc.).

The user can then confirm the user's bank account balance by contacting the user's bank. If sufficient funds are available, then the user can use the verification and spending limits processing disclosed hereto to obtain an increased sending limit.

The user can access the PayPal server via the user's client computer and the user can request a limit increase request form having one or more fields that are defined by the user. For example, the user can request that the form contain one or more fields that facilitate entry of the user's current bank account balance. As a further example, if the user recently paid off an auto loan, then the user can request that the form contain one or more fields that facilitate the entry of such information. After the user's sending limit has been increased, the user can then proceed with the initial payment transaction.

Some of the information shown in the form of FIG. 3 can be provided in a separate form. For example, the user's first and last names, account number, user name, and password could have been entered via the use of a previous form. Thus, such a form can have various different configurations and can require various different information.

This example of operation can be contrasted to exceeding a spending limit on credit card according to contemporary practice. When a user exceeds a spending limit on a contemporary credit card, there is simply no real-time, on-line system presently available for increasing the user's spending limit. According to contemporary practice, a new credit card account must be opened or an existing credit card account must be modified. Both require review of the account and user's credit history. A new credit card may have to be issued. Of course, this contemporary process is time consuming cannot be accomplished in real-time online.

Embodiments can be used in various different applications, including online payment systems such as PayPal and credit card system. Thus, limit increases can be requested for payment providers and credit cards.

Although increases of limits, scores, and such are discussed herein, those skilled in the art will appreciate that methods and systems disclosed herein can similarly be used to facilitate decreases in limits, scores and the like. Thus, a limit can be increased, decreased, or left unchanged as a result of a user's attempt to have a limit increased. Indeed, in some instances a user can intentionally have a limit decreased. In such instances, justification for a decrease may not be required.

As such, embodiments provide a user with a form that allows the user to provide information that the user believes will be useful to the payment provider in determining whether a limit increase is appropriate. More particularly, the form can omit superfluous fields that tend to be time consuming and annoying to fill out and that may be of little value (particularly in light of the added field(s)) to the payment provider in making such a determination.

That is, a user is not required to fill out all of the fields of a contemporary form. As those skilled in the art will appreciate, filling out all of the fields of such a contemporary form can be time consuming and annoying. Thus, one or more embodiments facilitate the use of a form wherein the fields are not predetermine and are not fixed.

According to contemporary practice, credit card limits are based upon user identity validation. User identify validation can be preformed using a social security number (SSN), credit history, and date of birth (DOB). Systems disclosed herein can provide a way to configure and process multiple options (such as confirmation of credit card, checking for chargeback on credit card, real-time identity validations, etc.) and a way to provide the user with the benefit of enhancing their ability to carry out payment transactions, such as sending money, withdrawing and receiving funds.

Embodiments described above illustrate, but do not limit, the invention. It should also be understood that numerous modifications and variations are possible in accordance with the principles of the present invention. Accordingly, the scope of the invention is defined only by the following claims.

1. A system comprising:
a non-transitory memory;
a real-time server with a real-time daemon configured to perform backend processing in real-time; and
one or more hardware processors coupled to the non-transitory memory and configured to read instructions from the non-transitory memory to cause the system to perform operations comprising:
receiving an indication that a financial transaction of a user is declined for exceeding a credit limit;
in response to receiving the indication, generating, by the real-time daemon in real time, a list of fields selectable by the user to update financial information;
presenting the list of fields in an online user interface of a user device of the user;
receiving, via the online user interface, at least one field selected by the user from the list of fields on the online user interface and financial information provided by the user via the at least one field; and
determining, by the real-time daemon, a credit limit increase for the user based on the financial information received via the at least one selected fields.
